(19) United States
(12) Patent Application Publication
(10) Pub. No.: US 2006/0271380 A1
(43) Pub. Date: Nov. 30, 2006

(54) Systems and methods for managing product satisfaction

(76) Inventor: Seshadri S. Chowdhury, Gilbert, AZ (US)

Correspondence Address: TASER INTERNATIONAL, INC., 17800 N. 85TH STREET, SCOTTSDALE, AZ, 85255-9603, US

(21) Appl. No.: 11/137,930

(22) Filed: May 25, 2005

(51) Int. Cl. G06Q 99/00

(52) U.S. Cl. 705/1

(57) ABSTRACT

Software hosted on a server aids a user having a possibly defective product at a user workstation coupled by a network to the server in performing diagnostics of the product; and, as needed, preparing a label for shipping the product to a service depot for analysis, test, maintenance, repair, upgrade, and/or replacement. The software includes a product support database having records for preparing presentations to the user. Hypertext presentations present the user with photos of products, descriptions of functional or structural features of those products, and symptoms; all linked for hierarchical access. Symptoms are listed in rank order according to current total number of accesses by all users. Each symptom is linked to an ordered list of steps forming a procedure for treating the symptom, possibly including obtaining a return material authorization (RMA) identifier. The software records all symptoms for which a procedure was provided to the user. If an RMA identifier is assigned, the recorded symptoms are associated with the RMA identifier. Resource planning software at the service depot provides a plan consistent with the recorded symptoms accessed by the RMA identifier. As a consequence of use of the software, products are less likely to be sent to the depot, and turnaround time at the depot is reduced, thereby improving customer satisfaction with the product and product support.

### FIELD OF THE INVENTION

Embodiments of the present invention relate to computer automated assistance with products believed to be unsatisfactory.

### BACKGROUND OF THE INVENTION

The sale of products to customers (also called “users”) generally includes making information available to the customer after the sale to assist the customer in obtaining full value of the product. Full value may include warranty repair or replacement bundled with the purchase price of the product. Information is conventionally provided by a printed operator manual, by telephone “call center” operators who may walk the caller through procedures presented on the call center operator's workstation, or by static hierarchical presentations of prearranged information, such as presentations of the type described in U.S. Pat. No. 5,539,869. Conventional automated customer support systems do not collect information from the user as the user interacts with the product and an automated customer support system. Consequently, products believed by the user to be unsatisfactory may be unnecessarily sent to a service depot. Information about unsatisfactory product operation is not available for improved product functions or improved design of new products.

### SUMMARY OF THE INVENTION

A method for providing computer automated assistance, according to various aspects of the present invention, for a product believed to be unsatisfactory is performed by a computer system coupled to a network for receiving and sending. The method includes, in any practical order: (a) sending indicia of an ordered first plurality of symptoms in response to a received request for symptoms describing unsatisfactory conditions of the product; (b) sending indicia of a respective plurality of steps in response to each received request for steps for treating a particular symptom of the first plurality of symptoms; (c) storing indicia of each particular symptom associated with each received request for steps, wherein an order for an ordered second plurality of symptoms to be sent is in accordance with the stored indicia of particular symptoms; (d) sending an authorization in response to a received request for authorization; and (e) providing a description of the product in association with indicia of the authorization, wherein the description of the product is in accordance with the indicia of each particular symptom.

Another method includes steps (a) through (e) discussed above wherein the second plurality of symptoms includes a second particular symptom; and the order for the ordered second plurality of symptoms is in accordance with a quantity of times the second particular symptom has been provided during a plurality of repetitions of the method.

Another method includes steps (a) through (e) discussed above wherein the method further includes storing indicia of performed steps in accordance with notice received that performed steps were performed; and the description of the product is in accordance with the indicia of performed steps.

A first computer system, according to various aspects of the present invention, is used by a plurality of users wherein a period of use is identified to a respective session identifier for each respective user and each respective period. The computer system includes a processor and a data storage subsystem operated by the processor. The data storage subsystem includes first, second, and third tables. The first table of records describes components. The second table of records describes symptoms. The third table of records describes each association of a particular record of the first table and a particular record of the second table, wherein the description of association includes indicia of a respective session identifier. The processor provides indicia of a first set of symptoms according to a rank of each symptom of the first set, the rank of each respective symptom being in accordance with a current respective count of records of the third table that refer to the respective symptom without regard to session identifiers in the records of the third table.

Another computer system includes all of the features of the first computer system discussed above and the following additional features. The data storage subsystem further includes a fourth table of records describing steps, each step being associated with a symptom of the second table. The processor further provides indicia of a respective second set of steps for each particular symptom of the first set.

The invention finds particular application in the support of consumer electronic products and software. For example, products such as handheld conducted energy weapons of the type described in U.S. Pat. No. 6,636,412 are expected to operate reliably in spite of rugged use by different officers on various shifts of police forces. Misunderstandings of configuration and battery supply arise in part due to multiple officers sharing use of a single serial number unit. A clerk in an armory for a police force having access to a product support server of the present invention may quickly resolve many issues of perceived unsatisfactory operation of conducted energy weapons in inventory and avoid the delays associated with shipping weapons to a service depot. On the other hand, weapons that require service at a depot may be more quickly attended to and returned due to efficiencies of product description (e.g., access by authorization identifier to a concise list of most informative and most probable symptoms) and authorization identifier determination as provided by a product support process of the present invention.

### BRIEF DESCRIPTION OF THE DRAWING

Embodiments of the present invention will now be further described with reference to the drawing, wherein like designations denote like elements, and:

FIG. 1 is a functional block diagram of a system for providing computer automated assistance, according to various aspects of the present invention, for a product believed to be unsatisfactory;

FIG. 2 is a process flow diagram of a method performed by a user of the system of FIG. 1;

FIG. 3 is a message sequence diagram for a sequence of exemplary messages provided during operation of the system of FIG. 1 according to the method of FIG. 2;

FIG. 4 is an entity relationship diagram of a product support database of the type used in an implementation of the system of FIG. 1; and

FIG. 5 is a an entity relationship diagram of a product support database of the type used in another implementation of the system of FIG. 1.

### DETAILED DESCRIPTION OF THE PREFERRED EMBODIMENTS

The problems described above are resolved in various implementations of the present invention. In an exemplary implementation that includes various aspects of the present invention, software is hosted on a server that aids a user having a possibly defective product. The user operates a user workstation that may be coupled to the server by a network. The user performs diagnostics or reconfigurations of the product as directed by the software. The system may assist the user, as needed, to prepare a label for shipping the product to a service depot for analysis, test, maintenance, repair, upgrade, and/or replacement. The software includes a product support database having records for preparing presentations to the user. In one implementation, hypertext presentations present the user with photos of products, descriptions of functional or structural features of those products, and symptoms; all linked for hierarchical access. Symptoms may be listed in rank order according to current total number of accesses by all users. Each symptom may be linked to an ordered list of steps forming a procedure for treating the symptom, possibly including obtaining a return material authorization (RMA) identifier. The software may record all symptoms for which a procedure was provided to the user. If an RMA identifier is assigned, the recorded symptoms may be associated with the RMA identifier. Resource planning software at the service depot may provide a plan consistent with the recorded symptoms accessed by the RMA identifier. As a consequence of use of the software, products are less likely to be sent to the depot, and turnaround time at the depot is reduced, thereby improving customer satisfaction with the product and product support.

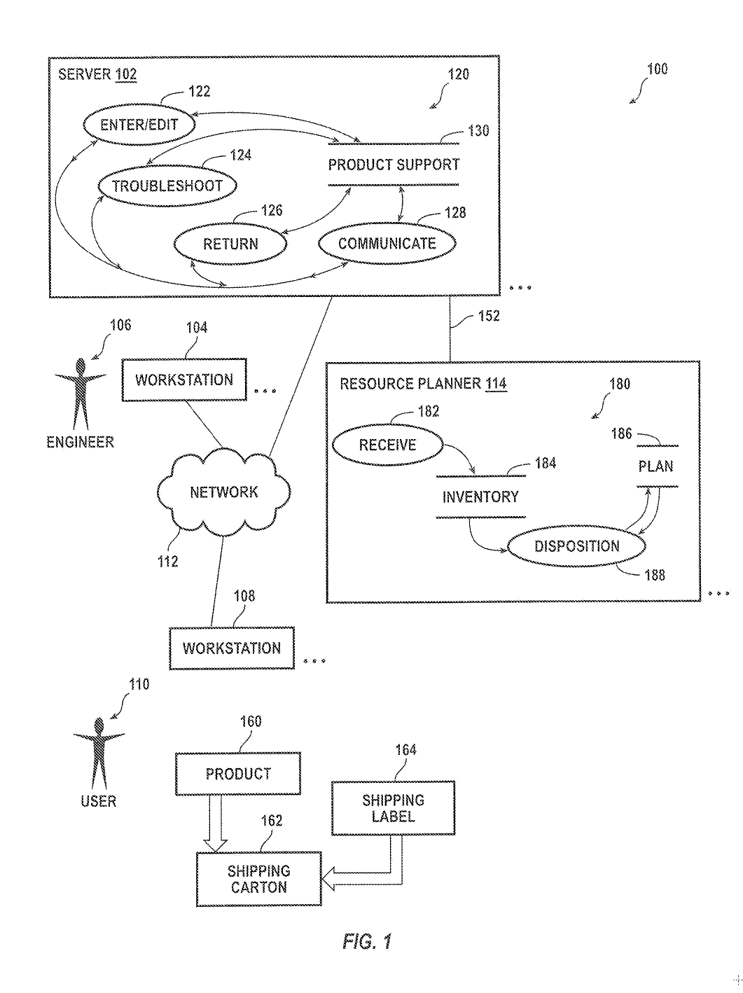

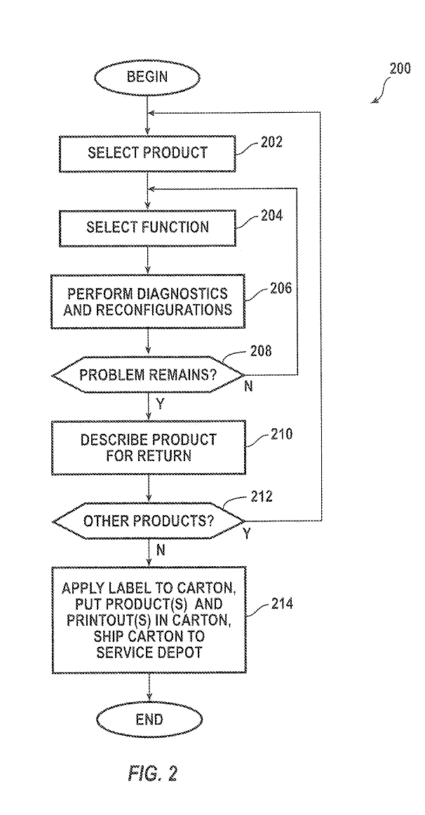

More generally, a system of the present invention improves customer satisfaction with products and product support. Such improvements may result from aiding a user having a possibly defective product, supplying information to a service depot for efficient servicing of the product, and/or supplying information for product improvements and new products. For example, system 100 of FIG. 1 includes any number of servers 102, a network 112, any number of workstations 104 and 108, and any number of resource planners 114. Servers, workstations, resource planners, and the network include conventional hardware and software for communication of the type supporting standards such as Hypertext Transmission Protocol (HTTP), Hypertext Markup Language (HTML), Extended Markup Language (XML), Internet browsers, Linux-based web service processes, JAVA virtual machines, PERL script interpreters, Structured Query Language (SQL), email, and interprocess communications. A preferred implementation was developed using the “.NET Framework” marketed by Microsoft, of Redmond, Wash.

A server includes any computer system that supports a product support process as discussed herein. Server 102 includes a conventional operating system that hosts a novel product support service 120. Product support service 120 includes enter/edit process 122, troubleshoot process 124, return product process 126, communicate process 128 and product support store 130. In operation, an engineer 106 may operate a workstation 104 to interact with enter/edit process 122 via network 112 and communicate process 128. Such interaction results in records created, edited, deleted, linked, and arranged in product support store 130. These records are accessed by troubleshoot process 124, return product process 126, and communicate process 128 so that a hierarchy of presentations may be navigated by user 110 to obtain product support for user 110. During such navigation, troubleshoot process 124, return product process 126, and communicate process 128 may index, search, add, edit, delete, and link existing and new records of product support store 130.

Resource planner 114 includes a conventional operating system that hosts a novel planning process configured to cooperate with server 102 and product support service 120. Servers 102 may be coupled in any conventional manner to resource planners 114 via one or more interfaces 152. Interface 152 may include any direct link or network. For example, planning process 180 includes receive process 182, inventory store 184, plan store 186, and disposition process 188. In operation, a user 110 may operate a workstation 108 for assistance with a product 160. If after navigating presentations prepared by troubleshoot process 124 and possibly entering data (e.g., answers via conventional dialog boxes and controls describing the product and/or results of diagnostics) the user is advised to send the product to a service depot, then interaction by user 110 and return process 126 results in, among other things, printing of a shipping label 164 by workstation 108 to be applied to the exterior of shipping carton 162 for sending product 160 to the service depot. A technician (not shown) receives shipping carton 162, inputs an authorization identifier from shipping label 164 into receive process 182, obtains a suitable plan prepared by plan process 180, and interacts with disposition process 188 to record performance of the plan. The plan may include instructions for treatment of symptoms identified by user 110 and troubleshoot process 124. The plan may include instructions for further analysis, testing, diagnostics, repairs, and/or upgrades to product 160. The plan may further include instructions for the technician to ship a repaired or upgraded product 160, or a replacement for product 160 back to user 110.

Plan process 180 may include conventional financial, scheduling, and work management functions including inventory management, material requirements planning, manufacturing planning, enterprise resource planning, and factory workflow scheduling. Inventory store 184 may include one or more conventional databases and may integrate service depot functions with ongoing manufacturing of existing and new product designs. Plan store 186 may include one or more conventional databases for plan templates and other information for preparing plans in advance suitable for returned product disposition. Plan store 186 may include records of plans that have been performed and other information for statistical analysis of product functions, failures, user successes and errors in operation and/or fault diagnosis as performed by conventional statistical analysis processes of plan process 180 (not shown).

In another implementation of system 100, network 112 is omitted, workstation functions are integral to server 102 (e.g., a personal computer), and functions of resource planner 114 are combined with server 102 to omit a separate resource planner 114 and interface 152. In such an implementation, the server includes a graphical user interface used from time to time by each of engineer 106, user 110 and the technician as discussed above. The hosting of product support processes 120 on a platform different from resource planner processes 180 may facilitate independent operation and geographical or political separation of these processes.

As discussed above, user 110 may perform a method at workstation 108 that results in product 160 being returned to service (e.g., failure not repeatable, or reconfiguration successful) or sent to a service depot. For example, method 200 begins with the user selecting (202) from products presented on workstation 108 by troubleshoot process 124 a product corresponding to product 160. Selection may be accomplished by the user operating a conventional pointing device and indicating selection (e.g., a mouse click on text or graphics identifying a product choice). The selected product is hereafter called the chosen product. By selecting a product, troubleshoot process 124 proceeds to a next (e.g., lower) level of hierarchical presentation. The user then, in a similar manner, selects (204) a structure or function of the chosen product believed to be associated with an unsatisfactory structure or function of product 160 (e.g., a mouse click on text or graphics for “battery”, “power”, or “display” when battery powered product 160 is believed to be dead and/or a display is blank). Suggested choices for structures and functions are presented on workstation 108 by troubleshoot process 124. The selected structure or function is hereafter called the chosen feature. By selecting the chosen feature, troubleshoot process 124 may proceed to an augmented display showing the chosen product, the chosen feature, and a list of symptoms.

A symptom as used herein includes any description (e.g., text, graphics, or video) of an unsatisfactory structure or function. For the dead product example, symptoms might include text such as a title of a diagnostic procedure or reconfiguration procedure (e.g., “AC power not connected to the product”, “Selecting 120Volt or 240Volt AC power”, “Battery improperly installed”, “Recharging the battery”).

The user may select one of the listed symptoms if he or she believes it to apply. By selecting a symptom, troubleshoot process 124 may provide a list of steps (herein called a procedure) to be performed (206) by the user for diagnostic test or reconfiguration of the product. If the unsatisfactory feature does not remain (208) after performing the procedure, troubleshoot process 124 allows the user to repeat selection (204) of an unsatisfactory structure or function. Trial an error may continue through iterations of the loop (204, 206, 208).

Otherwise, if the unsatisfactory feature remains (208) (i.e., user 110 so indicates to troubleshoot process 124 (e.g., by pointing and clicking a suggested response), troubleshoot process 124 passes control to return product process 126.

Return product process 126 presents to user 110 one or more forms to fill in (210) to identify the user (e.g., name and address), identify a suitable service depot (e.g., contracted vendor name and address), and further describe, if desired, the unsatisfactory nature of the product feature (e.g., writing out a comment “product is not dead but display dims and flickers”). When all forms are completed (e.g., including authorization for payment of depot services) and no further products are to be tested (212), return product process 126 may determine (e.g., assign) an authorization identifier and then direct a printer (not shown) of workstation 108 to print a shipping label 164 with the depot's address, the user's address, and the authorization identifier. User 110 then applies shipping label 164 to carton 162, packs product 160 (and other products or information) into carton 162, and ships carton 162 to the service depot.

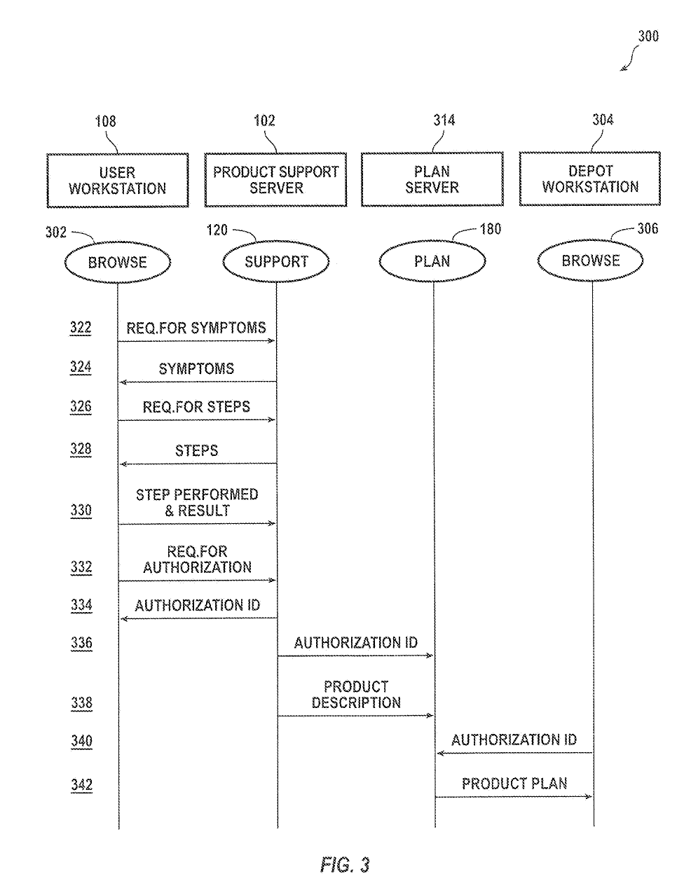

A product support process, according to various aspects of the present invention, sends and receives messages, determines an authorization identifier, and associates the authorization identifier with a description of a product being shipped to a depot, all of which to accomplish aiding a user with a product believed to be unsatisfactory. For example, in an implementation of product support process 120, messages form a sequence 300 of FIG. 3. As discussed above, user workstation 108 may include a browse process for sending and receiving messages via network 112. Product support server 102 may include support process 120 with communication capability 128 for sending and receiving messages via network 112. Resource planner 114 may be implemented as a plan server 314 having a plan process 180 that includes communication capability (e.g., similar to communicate process 128 if interface 152 includes a power not connected to the product”, “Selecting 120Volt or 240Volt AC power”, “Battery improperly installed”, “Recharging the battery”).

The user may select one of the listed symptoms if he or she believes it to apply. By selecting a symptom, troubleshoot process 124 may provide a list of steps (herein called a procedure) to be performed (206) by the user for diagnostic test or reconfiguration of the product. If the unsatisfactory feature does not remain (208) after performing the procedure, troubleshoot process 124 allows the user to repeat selection (204) of an unsatisfactory structure or function. Trial an error may continue through iterations of the loop (204, 206, 208).

Otherwise, if the unsatisfactory feature remains (208) (i.e., user 110 so indicates to troubleshoot process 124 (e.g., by pointing and clicking a suggested response), troubleshoot process 124 passes control to return product process 126.

Return product process 126 presents to user 110 one or more forms to fill in (210) to identify the user (e.g., name and address), identify a suitable service depot (e.g., contracted vendor name and address), and further describe, if desired, the unsatisfactory nature of the product feature (e.g., writing out a comment “product is not dead but display dims and flickers”). When all forms are completed (e.g., including authorization for payment of depot services) and no further products are to be tested (212), return product process 126 may determine (e.g., assign) an authorization identifier and then direct a printer (not shown) of workstation 108 to print a shipping label 164 with the depot's address, the user's address, and the authorization identifier. User 110 then applies shipping label 164 to carton 162, packs product 160 (and other products or information) into carton 162, and ships carton 162 to the service depot.

A product support process, according to various aspects of the present invention, sends and receives messages, determines an authorization identifier, and associates the authorization identifier with a description of a product being shipped to a depot, all of which to accomplish aiding a user with a product believed to be unsatisfactory. For example, in an implementation of product support process 120, messages form a sequence 300 of FIG. 3. As discussed above, user workstation 108 may include a browse process for sending and receiving messages via network 112. Product support server 102 may include support process 120 with communication capability 128 for sending and receiving messages via network 112. Resource planner 114 may be implemented as a plan server 314 having a plan process 180 that includes communication capability (e.g., similar to communicate process 128 if interface 152 includes a network). A depot workstation 304 (e.g., as used by a technician discussed above), may include a browse process 306 for communication with plan server 314. In such an implementation, plan server 314 may communicate with workstation 304 and server 102 via network 112.

Message sequence 300 begins with support process 120 receiving a request for symptoms from browse process 302. Such a request 322 may include indicia of a specific product (202) and feature (204) believed to be unsatisfactory. The indicia of product may be a conventional SKU. The indicia of product and/or feature may include a conventional uniform resource locator (URL) for use in preparing message 324. Messages from browse process 302 may conform to Hypertext Transmission Protocol (HTTP).

In response to the request (322), support process 120 may send indicia of one or more symptoms (e.g., a list or graphic arrangement of symptoms) to browse process 302. When indicia of several symptoms are to be sent, symptoms may be sent for presentation in a rank order. Ranking may be determined by how many times the symptom has been requested by all users over a suitable period of time (e.g., 3 months). By ranking symptoms, the time required for a user to arrive at a resolution for the unsatisfactory product is less than obtained on average using prior art technologies. Product description 338 and product plan 342 may also be more efficiently prepared. Messages to browse process 302 may conform to Hypertext Markup Language (HTML). The indicia of each symptom may include a conventional uniform resource locator (URL) for use in preparing message 326.

In response to the symptoms (324) and user selection (204), support process 120 may receive a request 326 for a procedure associated with the chosen symptom. A procedure may include a sequence of steps to be performed by the user. Each step may include text, graphics, audio and/or video. The indicia of each step may include a URL for example for use in playing the audio or video.

Product support process 120 may receive a message 330 from browse process 302 for one (e.g., the last of the sequence) or more (e.g., every) step performed by user 110. In addition to notice that a particular step was performed, message 330 may include a result (e.g., binary, enumerated selection, number, text, URL, and/or form) called for by the step and supplied or indicated (e.g., mouse click) by user 110.

Support process 120 may further receive from browse process 302 a request for authorization 332. The request may include a form (or contents of a form) defining all information for shipment of product 160 to a service depot as discussed above. Steps message 328 may include one or more presentations for collecting such information.

In response to request 332, support process 120 may send to browse process 302 a message 334 that includes a unique authorization identifier. Uniqueness may be as desired for trading off complexity and possibility of error. For example, the authorization identifier may be unique as to the particular depot, unique as to the particular product 160, unique as to all depots, unique as to all products, or unique as to all depots and all products.

At any convenient time after determination of an authorization identifier, support process 120 may send one or more messages 336 and 338 (e.g., as a set) that provide to plan server 314 the authorization identifier 336 in association with a product description 338. The product description may include all information collected for shipping product 160 to the depot as discussed above. In particular, message 338 preferably includes indicia of the symptom 324 associated (e.g., by user 110) with each message 326 that requested a procedure for such a symptom. Message 338 may include indicia of steps performed 330. Further, message 338 may include results 330 of steps performed.

Typically after shipping carton 162 is received at the service depot, a technician operating depot workstation 306 requests a plan from server 314. Browse process 306 sends a request for a plan 340 that includes the authorization identifier read by the technician from shipping label 164. In reply, plan process 180 sends a product plan 342 to browse process 306. As discussed above, the product plan 342 is developed by plan process 180 in accordance with product information 338 and conventional templates.

A product plan may include a list of actions to be accomplished by a technician and/or by automated equipment. Actions may refer to process control documentation (e.g., manufacturing standards). Each action may require certification of completion by a quality assurance inspector. When a-product plan is well defined, the cost of performing the plan may be estimated with accuracy sufficient for product improvement decision making as well as new product development decision making.

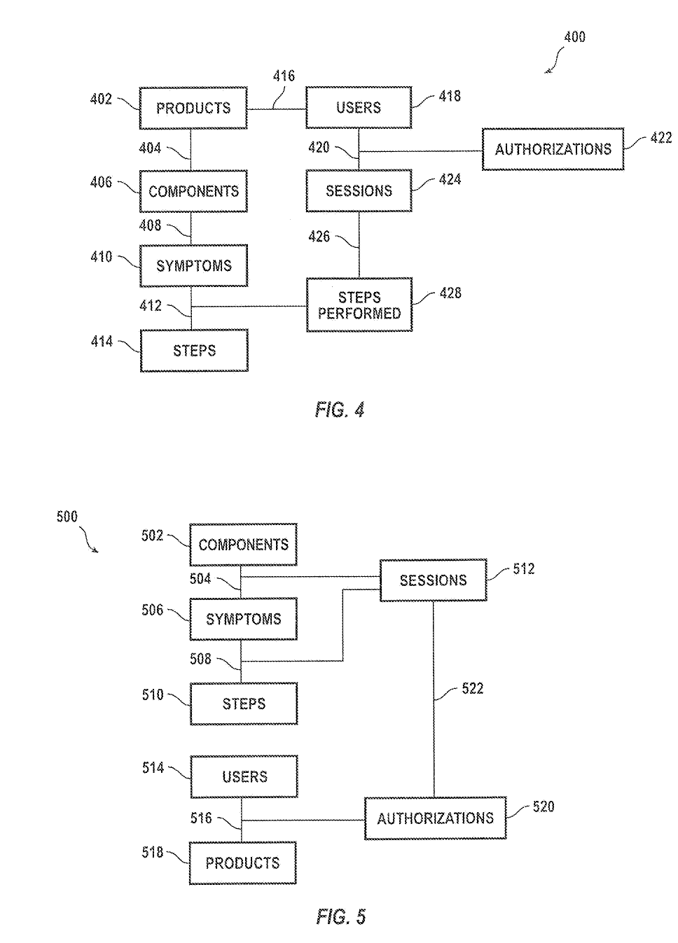

A store as discussed above may be implemented with any conventional data storage and database technologies including, for example, storage area networks, RAID arrays, distributed directory, relational databases, hierarchical databases, and combinations of these technologies. For example, data tables and relations between data tables may be implemented in accordance with schema 400 of FIG. 4. Schema 400 includes tables for products 402, components 406, symptoms 410, steps 414, users 418, sessions 424, authorizations 422, and steps performed 428. In addition, cross-reference indexes describe one to many and many to many relationships among tables. For example, each product may include many components (404), each component may have many symptoms (408), each symptom may be associated with a procedure (group) having many steps (412), each user may have many sessions (420), each session may refer to many steps performed (426), and each user may be associated with several products (416). Some of these relations may include additional information storage. For example, for each symptom-step relation, data is associated to describe whether the step was performed or not. For each user-session, data is associated to describe an authorization identifier if issued.

In one implementation of schema 400, a table and an associated cross-reference index are combined. Tables and fields of such an implementation are as follows. A Product-Component table includes in each record, ProductId, ComponentId, and ComponentDescription. A Component-Symptom table includes in each record ComponentId, SymptomId, and SymptomDescription. A Symptom-Step table includes in each record SymptomId, StepId, StepDescription, and StepEffectivity. A StepsPerformed table includes in each record SessionId, ProductId, ComponentId, SymptomId, StepId, and Result. A Users table includes UserId, Name, Address, Email, Phone, OrganizationName, and Department. A Product-User-Session table includes in each record ProductId, UserId, SerialNumber, SKU, WarrantyEndDate, WasProductStressed, StressDescription, and SessionId. A Session-User-Authorization table includes in each record SessionId, UserId, Date/Time, and AuthorizationId.

A SessionId is a unique identifier for each period of use by any user (e.g. 110 or 106). For example, a 25 alphanumeric character string is assigned by software performed by server 102 (e.g., communicate process 128, or network services software that may be a portion of the operating system or communication software utilities).

A reduced schema (not shown) derived from schema 400 for reporting but one symptom for each product includes a Product-User-Symptom-Authorization table that includes in each record ProductId, UserId, SKU, SerialNumber, WarrantyEndDate, WasProductStressed, StressDescription, SypmtomId, and AuthorizationId.

A schema 500 of FIG. 5 includes fewer tables than schema 400. Tables include components 502, symptoms 506, steps 510, sessions 512, users 514, products 518, and authorizations 520. Components may be defined uniquely across all products. A record of a User table and a record of a Product table may be used to collect information associated with shipping under a particular authorization as discussed above. When authorizations table 520 includes SessionId, cross-reference index 522 is omitted.

In a preferred implementation where tables are combined with cross-reference indexes, tables and indexes numbered 502-512 in FIG. 5 are replaced with four tables having fields as follows. No other files are needed for indexed access to symptoms in rank order or product description (e.g., symptoms, steps performed) associated with an authorization identifier. A Components table includes in each record SKU, ComponentId, and ComponentDescription. A Component-Symptom 504 table includes in each record ComponentId, SymptomId, and SymptomDescription. A SymptomStep table 508 includes SymptomId, StepId, and StepDescription. A Session-Component-Symptom table 512 includes SessionId, ComponentId, SymptomId, and Date/Time. In operation, upon establishing a connection between browser 302 and support process 120, a SessionId is created. Upon selection of each and every component by user 110 (like 202) (browser 302 generates message 322 received by support process 120), a record in table Session-Component-Symptom is created and stuffed with the SessionId, ComponentId for the chosen component, a null value for SymptomId, and the current date/time of record creation. By posting date/time, the time sequence of which procedures were followed can be determined from table Session-Component-Symptom. Upon selection of each and every symptom (like 204) (browser 302 generates message 326 received by support process 120), a new record in table Session-Component-Symptom is created this time having non-null values in all fields. To create message 324 with symptoms in rank order, trouble shooting process 124 obtains the list of symptoms from the Component-Symptom file corresponding to the desired component. Process 124 then counts the number of occurrences of each symptom of the list that occur in Session-Component-Symptom. Because table Session-Component-Symptom has a record for every message 326, troubleshooting process 124 may count the number of occurrences of the value of each symptom to determine a rank for each symptom. The larger the total count, the more toward the top of the list the symptom will be presented to user 110. Because the rank is simple to calculate, ranks may be counted on demand (e.g., on receipt of message 322 and in preparation of message 324).

To assure timely provision of ranks for requested symptoms, a table describing sessions and symptoms (e.g., table 418, table 512 of schema 500, or Session-Component-Symptom table 512 as discussed above) may be trimmed by the deletion of cumulative information that does not affect the ranking of various symptoms. For example, when ranks are unevenly distributed (e.g., a first rank has a value of 1207, a second rank has a value of 456, and a third rank has a value of 400) records may be deleted that would not affect relationships between ranked symptoms (e.g., after trimming the first rank has a value of 100, the second has a value of 80 and the third has a value of 60). Trimming may reestablish a linear interrelationship, or any well defined non-linear relationship (e.g., a conventional probability distribution function).

When a record is created and stored, the fields of the record are said to be associated. The association may be for storage, indexing, or recall. Consequently, forming an association between information of different types (e.g., field values) may be accomplished by creating, editing, and/or storing a record.

The foregoing description discusses preferred embodiments of the present invention which may be changed or modified without departing from the scope of the present invention as defined in the claims. While for the sake of clarity of description, several specific embodiments of the invention have been described, the scope of the invention is intended to be measured by the claims as set forth below.

What is claimed is:

1. A method for providing computer automated assistance for a product believed to be unsatisfactory, the method performed by a computer system coupled to a network for receiving and sending, the method comprising:
sending indicia of an ordered first plurality of symptoms in response to a received request for symptoms describing unsatisfactory conditions of the product;
sending indicia of a respective plurality of steps in response to each received request for steps for treating a particular symptom of the first plurality of symptoms;
storing indicia of each particular symptom associated with each received request for steps, wherein an order for an ordered second plurality of symptoms to be sent is in accordance with the stored indicia of particular symptoms;
sending an authorization in response to a received request for authorization; and
providing a description of the product in association with indicia of the authorization, wherein the description of the product is in accordance with the indicia of each particular symptom.

2. The method of claim 1 further comprising providing a product plan in response to received indicia of authorization.

3. The method of claim 1 wherein:
the second plurality of symptoms comprises a second particular symptom; and
the order for the ordered second plurality of symptoms is in accordance with a quantity of times the second particular symptom has been provided during a plurality of repetitions of the method.

4. The method of claim 1 wherein:
the method further comprises storing indicia of performed steps in accordance with notice received that performed steps were performed; and
the description of the product is in accordance with the indicia of performed steps.

5. A computer system programmed to perform the method of claim 1.

6. A computer system programmed to perform the method of claim 2.

7. A computer system programmed to perform the method of claim 3.

8. A computer system programmed to perform the method of claim 4.

9. A computer programmed product comprising instructions for a computer system to perform the method of claim 1.

10. A computer programmed product comprising instructions for a computer system to perform the method of claim 2.

11. A computer programmed product comprising instructions for a computer system to perform the method of claim 3.

12. A computer programmed product comprising instructions for a computer system to perform the method of claim 4.

13. A computer system for use by a plurality of users, a period of use being identified to a respective session identifier for each respective user and each respective period, the computer system comprising:
a processor;
a data storage subsystem operated by the processor, the data storage subsystem comprising:
(1) a first table of records describing components;
(2) a second table of records describing symptoms;
(3) a third table of records describing each association of a particular record of the first table and a particular record of the second table, wherein the description of association includes indicia of a respective session identifier; wherein
the processor provides indicia of a first set of symptoms according to a rank of each symptom of the first set, the rank of each respective symptom being in accordance with a current respective count of records of the third table that refer to the respective symptom without regard to session identifiers in the records of the third table.

14. The computer system of claim 13 wherein:
the data storage subsystem further comprises a fourth table of records describing steps, each step being associated with a symptom of the second table; and
the processor further provides indicia of a respective second set of steps for each particular symptom of the first set.

15. The computer system of claim 14 wherein:
the third table comprises records describing each association of a particular record of the first table, a particular record of the second table, and at least one particular record of the fourth table indicated in a particular session as a performed step, wherein the description of association includes indicia of a the particular session identifier; and
the processor further provides indicia of performed steps in association with a symptom of a session.
